(19) United States
(12) Patent Application Publication
(10) Pub. No.: US 2025/0311757 A1
(43) Pub. Date: Oct. 9, 2025

(54) HEALTHY CRISP SNACK FOOD PRODUCT

(71) Applicant: OHPOPS! FUNCTIONAL FOODS A/S, Copenhagen (DK)

(72) Inventor: Ole Bent Nielsen, Copenhagen (DK)

(21) Appl. No.: 18/866,136

(22) PCT Filed: May 19, 2023
(86) PCT No.: PCT/EP2023/063516

§ 371 Date: Nov. 15, 2024

(30) Foreign Application Priority Data
May 19, 2022 (DK) PA202200472

(51) Int. Cl. A23L 7/17; A23J 3/14; A23J 3/26; A23L 7/10; A23L 7/126; A23P 30/20

(52) U.S. Cl. CPC A23L 7/17; A23J 3/14; A23J 3/26; A23L 7/101; A23L 7/126; A23P 30/20

(57) ABSTRACT

The present disclosure relates to a snack food product comprising: a) 10 wt % to 75 wt % of total carbohydrate (TC) comprising less than 20 wt % sugars, less than 50 wt % starch and at least 1 wt % dietary fibers (DF); and b) 10 wt % to 75 wt % of protein.

### TECHNICAL FIELD

The invention described herein relates to a healthy crisp snack food product and processes for producing it.

### BACKGROUND

Snack foods represents a huge and expanding world-wide marked. However, most snacks have inferior to negative nutritional value, typically containing excessive amounts of salt, sugars, simple carbohydrates and saturated or semi-saturated fats.

Accordingly, there is an ongoing quest for developing more healthy snacks. Opinion leaders in the field such as published in Schlinkert et al.; “The snack that has it all: People's associations with ideal snacks”; Appetite 152 (2020) 104722″ summarizes important points: “Taste expectations are among the main drivers of food decisions” (Kourounitis et al, 2016; Li, Streletskaya, & Gomez, 2019). “The marketing of unhealthy foods as tasty makes it therefore very difficult for people to follow up on their healthy eating goals” (Glanz, Basil, Maibach, Goldberg, & Snyder, 1998). “This eventually results in diets of poorer nutritional quality, and lower fruit and vegetable intake” (Kuorouniotis et al, 2016). “Considering that many people want to eat more healthy foods (whole grains, fruits and vegetables, low in fat, sugar and salt), there is an urgent need for healthy snacks that make an appeal to taste, just as unhealthy snacks do, to support people in eating as they want” (Mai & Hoffmann, 2015). “Obesity and concurrent public health issues are a global problem, and snacking plays an important role in people's (un) healthy diets” (Heymsfield & Wadden, 2017; Nielsen et al, 2002). “Therefore, changing peoples snack choices is a promising avenue for an improved diet. However educating consumers has not led to significant improvements or fundamental changes in food choices” (Swinburn et al., 2011).

Improving the availability of snacks that are not just healthy, but also in line with people's preferences and associations with ideal snacks is therefore needed. US 2009/0155444 describes food materials containing a high concentration of vegetable protein and whole grains and processes for their manufacture, including protein extrudates containing high concentrations of soy protein and whole grains, and processes for manufacturing such protein extrudates.

US2014/0314932 describes high protein expanded products produced by extrusion of wheat protein isolates, modified wheat starch, salts, gums and moisture. The product is extruded from a twin-screw extruder with the temperatures in the range of 50 to 140′ C, screw speeds of 250 to 450 rpm and with a back pressure of 350 to 1200 psi for different recipes. A range of expanded wheat crisps and other expanded products with wheat protein contents ranging from 30 to 90% are obtained from this process.

WO2015/091517 describes a process for a preparing a a light puffed hollow snack allegedly having unique properties. The process comprises the steps of (a) mixing a composition including at least 20 wt. % starch ingredient, (b) adding water to increase the total moisture content of the mixture to 25-45 wt. %, (c) extruding the mixture at 5-70 deg C and 50-90 bar, (d) cutting the extruded mixture into pieces and (e) heating in an oven.

None of this art, however, provides a solution for how to provide a snack which is healthy, nutritious and dietarily safe and at the same time a well tasting or tolerably tasting, savoury or tolerably savoury and crisp product with attractive texture, mouthfeel and palatability.

### SUMMARY

The present disclosure describes improved snack food products and processes for their manufacture offering solutions to certain drawbacks of the background art including but not limited to providing a product which is high in protein and essential amino acids, low in carbohydrates and in sugars, but with high percentage of prebiotic dietary fibres and at the same time a well tasting, savoury and crisp/crunchy product with excellent texture, mouthfeel and palatability—a vegan product which is free of known top allergens.

Accordingly in a first aspect disclosed herein is a snack food product comprising:
a) 10 wt % to 75 wt % of total carbohydrate (TC) comprising less than 20 wt % sugars, less than 50 wt % starch and at least 1 wt % dietary fibers (DF); and
b) 10 wt % to 75 wt % of protein.

In a further aspect described herein is a process for producing the snack food product described herein comprising
a) providing the carbohydrate and the protein and optionally water and mixing the ingredients into a composition A;
b) extruding composition A in an extruder to produce a composition B;
c) collecting and drying the extruded composition B to produce the snack food product; and
d) optionally adding a lipid and/or one or more spices to the snack food product.

In a further aspect described herein is a packaged snack food product, comprising 15 to 500 grams of the snack food product described herein, contained in a sealed foil wrapping comprising one or more prints on an external surface.

### DESCRIPTION OF DRAWINGS AND FIGURES

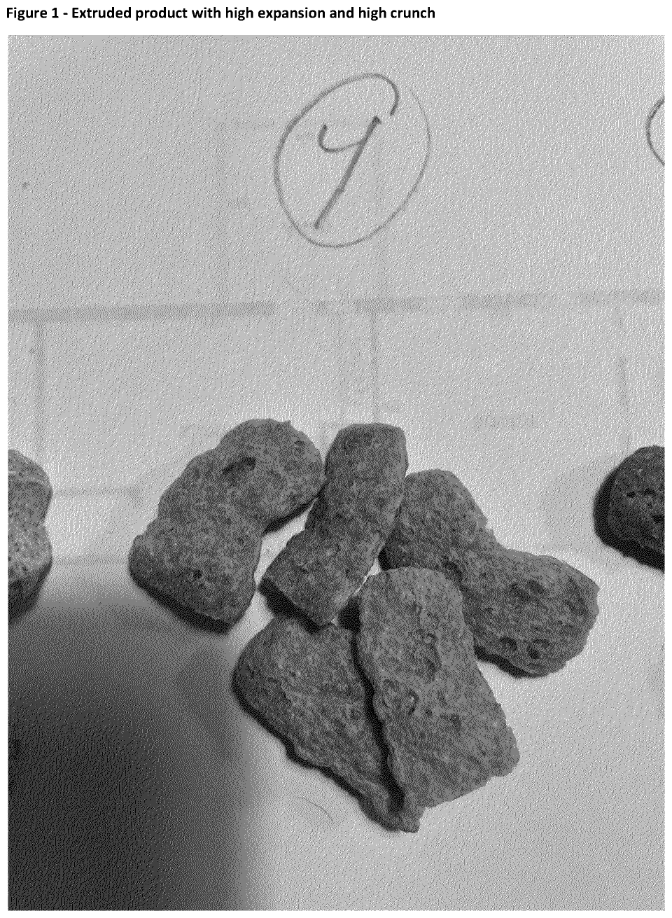

In the figures included herein FIG. 1 shows an extruded snack product having an outstanding nutritional and health promoting profile and

### INCORPORATION BY REFERENCE

All publications, patents, and patent applications referred to herein are incorporated by reference to the same extent as if each individual publication, patent, or patent application was specifically and individually indicated to be incorporated by reference. In the event of a conflict between a term herein and a term in an incorporated reference, the term herein prevails and controls.

### DETAILED DESCRIPTION

### Definitions

The term “% wt” as used herein refers to the weight of a substance in a composition in percent of the total weight of the composition.

### Snack Food Product

The features and advantages of the present invention is readily apparent to a person skilled in the art by the below detailed description of embodiments and examples of the invention with reference to the figures and drawings included herein.

It is a tremendous challenge and to develop snacks which are vegan and healthy—meaning that it is high quality in protein, high in dietary fibers, low in sugars, low in starch, and low in fats—while still taste well or at least tolerable and remains crispy and delicate.

The invention described herein concerns such a snack food products which fulfills these criteria and results from testing of many types of ingredient and manufacture processes. Accordingly, described herein is a crisp and well or tolerably tasting snack food products which comprises
a) 10 wt % to 75 wt % of total carbohydrate (TC) comprising less than 20 wt % sugars, less than 50 wt % starch and at least 1 wt % dietary fibers (DF); and
b) 10 wt % to 75 wt % of protein.

In some embodiments the total amount of carbohydrate in the snack food product is 15 wt % to 50 wt %, optionally between 20 wt % to 45 wt %, optionally between 25 wt % to 40 wt %, optionally between 25 wt % to 35 wt %, optionally between 28 wt % to 32 wt %, optionally between 29 wt % to 31 wt %. The snack food product can in some embodiments include between 1.0 wt % to 15.0 wt % sugars, optionally between 2.0 wt % to 10.0 wt % sugars, optionally between 2.0 wt % to 8.0 wt % sugars, optionally between 2.0 wt % to 6.0 wt % sugars, optionally between 3.0 wt % to 4.5 wt % sugars, optionally between 3.0 wt % to 4.5 wt % sugars, optionally between 3.8 wt % to 4.1 wt % sugars, optionally between 3.2 wt % to 3.4 wt % sugars. Such sugars may be selected from the group of glucose, fructose, sucrose, maltose, and lactose. In additional or alternative embodiments, the snack food product can include between 10.0 wt % to 45.0 wt % starch, optionally between 15.0 wt % to 30.0 wt % starch, optionally between 20.0 wt % to 25.0 wt % starch, optionally between 21.0 wt % to 23.0 wt % starch, optionally between 21.9 wt % to 22.1 wt % starch, optionally between 22.8 wt % to 23.0 wt % starch. In further additional or alternative embodiments, the snack food product can include between 1 wt % to 20 wt % dietary fibers, optionally between 2 wt % to 18 wt % dietary fibers, optionally between 4 wt % to 16 wt % dietary fibers, optionally between 6 wt % to 14 wt % dietary fibers, optionally between 8 wt % to 12 wt % dietary fibers, optionally between 10 wt % to 12 wt % dietary fibers. Dietary fiber are carbohydrates originating from plant which are wholly or partially indigestible and are not fully broken down or absorbed in the human digestive system and remains wholly or partially intact as it moves through the gastrointestinal tract. In some embodiments the dietary fibers are soluble in aqueous solvent and forms a gel-like substance. In other embodiments the dietary fibers are insoluble in aqueous solvent. In further embodiments of the ratio of TC to DF (TC:DF) in the snack food product is between 1.0:1.0 and 10.0:1.0, optionally between 1.5:1.0 and 5.0:1.0, optionally between 2.0:1.0 and 4.9:1.0, optionally between 2.5:1 and 4:1, optionally between 2.50:1 to 2.60:1, optionally optionally between 3.7:1 to 3.9:1. Further, the snack food product can include between 10 wt % to 60 wt % protein, optionally between 15 wt % to 55 wt % protein, optionally between 20 wt % to 50 wt % protein, optionally between 25 wt % to 50 wt % protein, optionally between 30 wt % to 50 wt % protein, %, optionally between 35 wt % to 40 wt % protein, optionally between 35 wt % to 36 wt % protein, optionally between 37 wt % to 38 wt % protein. The protein in the snack food product preferably comprises at least 10 different amino acids, optionally at least 11 different amino acids, optionally at least 12 different amino acids, optionally at least 13 different amino acids, optionally at least 14 different amino acids, optionally at least 15 different amino acids, optionally at least 16 different amino acids, optionally at least 17 different amino acids, optionally at least 18 different amino acids, optionally at least 19 different amino acids, optionally at least 20 different amino acids. Further, the protein in the snack food product preferably comprises at least 5 essential amino acids, optionally at least 6 essential amino acids, optionally at least 7 essential amino acids, optionally at least 8 essential amino acids, optionally at least 9 essential amino acids. Still further, the snack food product may include a source of lipid, a source of flavour and/or moisture. The oil may comprise one or more unsaturated fatty acids, optionally selected the group of omega-3, omega-6 and omega-9 fatty acids and may be a vegetable oil for example selected from the group of rape seed oil (Brassica napus), grape seed oil (Vitis vinifera), olive oil (Olea); sunflower oil (Helianthus annuus); soybean oil (Glycine max), corn oil (Zea mays); sesame oil (Sesamum indicum), coconut oil (Cocos nucifera), palm oil (Elaeis), avocado oil (Persea americana), safflower oil (Carthamus tinctorius). The flavour may be s a spice, optionally selected from salt, peppers including chili peppers, wasabi (horse radish), mustard, basil, thyme, tomatoe, oregano, garlic, onion, majoram, rosemary, beetroot, lemon, vanilla, cocoa, caramel, honey, coffee, lime, banana, cherry, strawberry, blueberry, mint, apricot or combination thereof. In some embodiments the amount of lipid and/or oil is between 5 wt % to 20 wt %, optionally between 8 wt % to 10 wt %. in other embodiments the amount of flavour and/or spice is between 5 wt % to 20 wt %, optionally between 8 wt % to 10 wt %. In additional or alternative embodiments the snack food product comprises less than 10 wt % water, optionally less than 8 wt % water, optionally less than 6 wt % water, optionally less than 4 wt % water, optionally less than 2 wt % water, optionally less than 1 wt % water.

The carbohydrate of the snack food product may suitably be derived from grain, optionally cereal grains, optionally one or more grains selected from wheat (Triticum aestivum), barley (Hordeum vulgare), rye (Secale cereale), oats (Avena sativa), rice (Oryza sativa), corn (Zea mays), millet (Panicum miliaceum), sorghum (Sorghum bicolor), quinoa (Chenopodium quinoa), and buckwheat (Fagopyrum esculentum). Such grain may be in the form of flour where seed husks has been removed or it may be whole grain flour where the whole seed has been milled. The snack food product may comprise between 20 wt % to 60 wt % grain, optionally between 25 wt % to 55 wt % grain, optionally between 30 wt % to 50 wt % grain, optionally between 30 wt % to 40 wt % grain, optionally between 33 wt % to 38 wt % grain, optionally between 34 wt % to 35 wt % grain.

The protein of the snack food product may be derived from a legume, optionally selected from the group of Soybeans (Glycine max), lentils (Lens culinaris), chickpea (Cicer arietinum), beans (Phaseolus vulgaris), peas (Pisum sativum) including green peas, brown peas and yellow split peas (Pisum sativum var. arvense). The snack food product may suitably comprise between 20 wt % to 60 wt % legume, optionally between 25 wt % to 55 wt %, optionally between 30 wt % to 50 wt %, optionally between 30 wt % to 40 wt %, optionally between 33 wt % to 38 wt %, optionally between 34 wt % to 35 wt % legume. In some embodiments the snack food product comprises between 10 wt % to 30 wt % legume protein, optionally between 12 wt % to 28 wt %, optionally between 15 wt % to 25 wt %, optionally between 15 wt % to 20 wt %, optionally between 15 wt % to 19 wt %, optionally between 17 wt % to 18 wt % legume protein.

Alternatively or additionally, the protein may be derived from hemp (Cannabis sativa). The snack food product may suitably comprise between15 wt % to 55 wt % hemp, optionally between 20 wt % to 50 wt %, optionally between 25 wt % to 45 wt %, optionally between 25 wt % to 35 wt %, optionally between 29 wt % to 32 wt %, optionally between 30 wt % to 31 wt % hemp. In some embodiments the snack food product comprises between 9 wt % to 36 wt % hemp protein, optionally between 13 wt % to 32 wt %, optionally between 16 wt % to 29 wt %, optionally between 16 wt % to 22 wt %, optionally between 19 wt % to 21 wt %, optionally between 19.5 wt % to 19.8 wt % hemp protein.

Alternatively or additionally the protein may be derived from grain such as wheat (Triticum aestivum), barley (Hordeum vulgare), rye (Secale cereale), oats (Avena sativa), rice (Oryza sativa), corn (Zea mays), millet (Panicum miliaceum), sorghum (Sorghum bicolor), quinoa (Chenopodium quinoa), and buckwheat (Fagopyrum esculentum). In some embodiments the snack food product comprises between 1 wt % to 15 wt % grain protein, optionally between 2 wt % to 12 wt %, optionally between 3 wt % to 8 wt %, optionally between 4 wt % to 6 wt % grain protein.

In some embodiments the protein is derived from both legumes, hemp, and grains.

In a special embodiment the snack food product of any preceding claim comprises:
a) between 20 wt % to 60 wt % of ground grain, optionally between 25 wt % to 55 wt % grain, optionally between 30 wt % to 50 wt % grain, optionally between 30 wt % to 40 wt % grain, optionally between 33 wt % to 38 wt % grain, optionally between 34 wt % to 35 wt % grain, selected from wheat (Triticum aestivum), barley (Hordeum vulgare), rye (Secale cereale), oats (Avena sativa), rice (Oryza sativa), corn (Zea mays), millet (Panicum miliaceum), sorghum (Sorghum bicolor), quinoa (Chenopodium quinoa), and buckwheat (Fagopyrum esculentum);
b) between 20 wt % to 60 wt % legume, optionally between 25 wt % to 55 wt %, optionally between 30 wt % to 50 wt %, optionally between 30 wt % to 40 wt %, optionally between 33 wt % to 38 wt %, optionally between 34 wt % to 35 wt % legume, selected from the group of soybeans (Glycine max), lentils (Lens culinaris), chickpea (Cicer arietinum), beans (Phaseolus vulgaris), peas (Pisum sativum) including green peas, brown peas and yellow split peas (Pisum sativum var. arvense;
c) between 15 wt % to 55 wt % hemp, optionally between 20 wt % to 50 wt %, optionally between 25 wt % to 45 wt %, optionally between 25 wt % to 35 wt %, optionally between 29 wt % to 32 wt %, optionally between 30 wt % to 31 wt % hemp;
d) optionally between 5 wt % to 20 wt %, optionally between 8 wt % to 10 wt % oil, selected from the group of rape seed oil (Brassica napus), grape seed oil (Vitis vinifera), olive oil (Olea); sunflower oil (Helianthus annuus); soybean oil (Glycine max), corn oil (Zea mays); sesame oil (Sesamum indicum), coconut oil (Cocos nucifera), palm oil (Elaeis), avocado oil (Persea americana), safflower oil (Carthamus tinctorius), and
e) optionally between 5 wt % to 20 wt %, optionally between 8 wt % to 10 wt % of flavour, selected from salt, peppers including chili peppers, wasabi (horse radish), mustard, basil, thyme, tomatoe, oregano, garlic, onion, majoram, rosemary, beetroot, lemon, vanilla, cocoa, caramel, honey, coffee, lime, banana, cherry, strawberry, blueberry, mint, apricot or combination thereof.

In additional or alternative embodiments, the snack food product comprises or consists of:
c) between 29 wt % to 31 wt % of carbohydrates comprising
   i. between 3.2 wt % to 3.4 wt % sugars comprising glucose, fructose, sucrose, maltose; and lactose;
   ii. between 22.8 wt % to 23.0 wt % starch, and
   iii. between 11.0 wt % to 12.0 wt % dietary fibers; and
d) between 35 wt % to 36 wt % protein, and
   wherein the ratio of TC to DF (TC:DF) is between 2.50:1.0 and 2.60:1.0.

In further special embodiments the snack food product consists of
a) 33 to 36% wt of carbohydrates consisting of
   i) a low amount of 4 to 5% wt of sugars comprising glucose, fructose, sucrose, maltose; and lactose
   ii) a limited amount of 20 to 21% wt of starch, and
   iii) a very high amount of 9 to 10% wt of dietary fibers
b) a very high amount of 31 to 35% wt of protein;
c) one or more vegetable lipids comprising omega 3; and
d) Water and spices adding up to 100%; and
   wherein the ratio fiber: total carbohydrate is between 3:1 and 4:1.

In a particular embodiment the snack food product described herein comprises 34% wt of carbohydrates consisting of 4.3% wt of sugars comprising glucose, fructose, sucrose, maltose; and lactose; 20.2% wt of starch; and 9.5% wt of dietary fibers, and wherein the ratio fiber: total carbohydrate is between 3.4:1.

The protein of the snack food product has excellent nutritional properties and comprises in some embodiments at least 5 essential amino acids, optionally at least 6 essential amino acids, optionally at least 7 essential amino acids, optionally at least 8 essential amino acids, optionally at least 9 essential amino acids. In a preferred embodiment the sources of the ingredients are all natural consisting of oats (vena sativa), brown pea (Pisum sativum), hemp (Cannabis sativa), oil of rape seed (Brassica napus), spices and water. More specifically the snack food product consists of ground full grain oats (Avena sativa), brown pea (Pisum sativum) protein, hemp (Cannabis sativa) protein, oil of rape seed (Brassica napus), spices and water.

In more embodiments the snack food product is further characterized by having amounts below detection limit of allergens from egg, cow's milk, fish, shellfish, peanut, tree nut, soy, wheat, sesame, or celery, and free of gluten, sulphites, acetylsalisylate and salicylate.
2. The snack food product may further contain one or more added vitamins, optionally selected from vitamins A, B5, B7, B12, C, D, E, and/or K. Betaglucan, particularly isolated from oats may also be added to the snack food product as well as minerals optionally comprising essential minerals selected from calcium, chromium, iodine, molybdenum, and selenium, and/or powder omega-3 fatty acid for further increasing the nutritional value.

The snack food product is preferably a puffed crispy product, optionally having a density between 25 g/L to 200 g/L, optionally between 50 g/L to 150 g/L, optionally between 50 g/L to 100 g/L, optionally between 60 g/L to 90 g/L, optionally between 70 g/L to 80 g/L, optionally between 100 g/L to 150 g/L, optionally between 130 g/L to 140 g/L.

In another aspect described herein is a process for producing the snack food product described herein, comprising:
a) providing the carbohydrate and the protein and optionally water and mixing the ingredients into a composition A;
b) extruding composition A in an extruder to produce a composition B;
c) collecting and drying the extruded composition B to produce the snack food product; and
   optionally adding a lipid and/or one or more spices to the snack food product

In the process the extruder may be a screw extruder, optionally having a die plate with an opening between 5 mm² to 100 mm², optionally between 10 mm² to 75 mm², optionally between 12 mm² and 50 mm², optionally between 15 mm² and 40 mm², optionally between 15 mm² and 20 mm², optionally between 15 mm² and 17 mm². The opening in the die plate may be circular or oval or rectangular or square.

Further, the extrusion may be made at a pressure of between 5 bar to 300 bar, 7 bar to 150 bar 7 bar to 50 bar, optionally between 10 bar to 35 bar, optionally between 15 bar to 30 bar, optionally between 20 bar to 25 bar.

Still further, the extrusion may be made at a melt temperature between 50° C. to 200° C., optionally between 100° C. to 200° C., optionally between 125° C. to 175° C., optionally between 150° C. to 175° C.

Still further, the extrusion may be made at a a barrel temperature of between 25° C. to 200° C.

Still further, the extruder may be run with a torque between 25% to 50%, optionally between 30% to 40%.

Still further, extruder may provide for a throughput through the die plate of between 30 kg/h to 45 kg/h, optionally between 32 kg/h to 43 kg/h, optionally between 34 kg/h to 36 kg/h.

Still further, the extruder may provide for a screw speed of between 50 rpm to 1800 rpm, optionally between 100 rpm to 1800 rpm, optionally between 300 rpm to 1800 rpm, optionally between 600 rpm to 1800 rpm, optionally from 700 rpm to 1700 rpm, optionally from 900 rpm to 1600 rpm, optionally from 900 rpm to 1500 rpm, optionally from 1000 rpm to 1400 rpm, optionally from 1100 rpm to 1300 rpm.

In a special embodiment the process for producing the snack food product comprises:
a) Providing ground full or whole grain oats (Avena sativa), hemp (Cannabis sativa) protein, and brown pea (Pisum sativum) protein, and mixing the ingredients into a composition, A;
b) mixing composition A with rape seed oil (Brassica napus), one or more spices and water to produce a composition B;
c) extruding composition B in a screw extruder comprising a die plate with an opening of between 15 mm² and 17 mm² at conditions selected to maintain i) a pressure of 20 to 25 bar and b) a maximum temperature of between 150° C. to 175° C.; and
d) collecting drying and cooling the extruded composition B.

In a preferred embodiment the screw speed in the extruder s set to i) a screw speed of between 1100 to 1300 rpm.

In another embodiment water is added to composition A and oil and spices are added after the extrusion and drying step.

In another embodiments the process for producing the snack food product comprises:
a) Providing ground full or whole grain oats (Avena sativa), hemp (Cannabis sativa) protein, and brown pea (Pisum sativum) protein, and mixing the ingredients with water to produce a composition A;
b) extruding composition A in a screw extruder set to a screw speed of 1100 rpm to 1300 rpm comprising a die plate with an opening of between 15 mm² and 17 mm² at conditions selected to maintain i) a pressure of 20 to 25 bar and b) a maximum temperature of between 150° C. to 175° C.;
c) collecting and drying the extruded composition B to less than 4% wt water; and
d) optionally adding oil and flavour to the extruded composition B.

The process for producing the snack food product may also include cutting the extruded composition, B, into pieces and (e) heating the pieces for further crispiness and/or texture.

The snack food product is preferably further processes into a packaged snack food product, comprising 15 to 30 grams of the snack food product, contained in a sealed foil wrapping comprising one or more color prints on an external surface.

The ingredients of the snack food product may be ground prior to the mixing by method such as those described in Jones et al. “Nutritional Impacts of Different Whole Grain Milling Techniques: A Review of Milling Practices and Existing Data 1”; Cereal Foods World, pp 130-139; May-June 2015, vol. 60, no. 3.

### WORKING EXAMPLES

In the pursuit of snack foods which are both healthy with no allergens, well or tolerably tasting as well as having the perfect crunch or crispiness a long list of ingredients was tested including hemp flour, hemp protein, brown pea protein, whole grain oat, Faba pea protein from yellow pea protein, Potato protein, potato starch, potato flakes, maize flour, maize starch, maize flakes, oat flour, wheat flour, potato flour, egg white, egg yolk, egg white and yolk.

More than 200 tests were made to find the best mixture of ingredients which gave the desired nutritional and taste properties and at the same time could be puffed by extrusion to a crunchy/crispy product. A major obstacle was to find a healthy mixture which could expand in the puffing extrusion process without using excess flour, starch or any other additives as done in the traditional way when snacks are puffed. Some ingredients gave reduced expansion/crunch, some made the taste “earthy” and others just had a poor amino acid profile. It was found that protein and fiber rich ingredients impacted the expansion negatively and therefore using nutritionally more attractive ingredients such as whole grain cereals instead of normal flour/starch was a challenge to be overcome.

### Example 1

Upon testing the many different ingredients and different settings in the manufacture process, it was found that ground full grain oats in combination with protein extracted from brown peas and hemp, and oil from rape seeds produced the best taste and crunch/crisp properties, where the recipe was as shown in table 1.

TABLE 1
Recipe A

| Ingredient | Amount |
|---|---|
| Carbohydrate | 34% wt distributed as 4 to 5% wt of sugars |
| | comprising glucose, fructose, sucrose, maltose; |
| | and lactose, 20 to 21% wt of starch, and 9 |
| | to 10% wt of dietary fibers |
| Protein from oats, | 23 to 34% wt |
| peas and hemp | |
| Oil from rape seeds, | Up to 100% wt |
| water and spices | |

This combination provided for an outstanding nutritional profile of low carbohydrates/sugars, high in dietary fibres, high in protein, high in essential amino acids and high in omega 3 and 6 fatty acids as well as an excellent ratio of total carbohydrates to dietary fibres of 3.4:1.

This mixture was further subjected to optimizing the settings in the manufacture process to obtain the optimal crunch and crispiness. Here it was found that mixing full grain oats, the hemp, and the brown pea protein, and mixing the ingredients into a composition A; and sequentially or simultaneously mix in the rape seed oil, desirable spices such as wasabi powder, chili powder, ground dried basil and water and then extrude this mixture in a Coperion twin screw lab extruder using a on e hole 1.5×11 mm die plate using the below settings was most promising. The rape seed oil and desirable spices were also added after extruding composition A for optimal result.

| Test | 1 | 2 | 3 | 4 |
|---|---|---|---|---|
| Recipe | A | A | A | A |
| Water contents | High | High | Low | Low |
| Screw no. | Wholi V1 | Wholi V1 | Wholi V1 | Wholi V1 |
| Screw Speed | 1800 | 1000 | 1040 | 1200 |
| Torque % | 25 | 41 | 29 | 33 |
| Torque Throughput kg/h | 30 | 30 | 30 | 30 |
| SME Wh/kg | 250 | 227.78 | 168.673 | 221.467 |
| Crunch test 10 = best | 8 | 9 | 7 | 10 |

After extrusion the product was dried to a water content of less than 4% wt. The crunchiness or crispness was evaluated by a panel of 5 experienced snack food specialists. The best crunchiness (see FIG. 1) (score 10 of 10) was obtained in test 4, where the extruder was set so that a pressure of 20 to 25 bar and a maximum temperature of between 150° C. to 175° C. was maintained during the extrusion.

### Example 2

Another recipe, B, as shown in table 2, having no oil or spices was also tested.

TABLE 1
Recipe A

| Ingredient | Amount |
|---|---|
| Carbohydrate | 30% wt distributed as 4 to 5% wt of sugars |
| | comprising glucose, fructose, sucrose, |
| | maltose; and lactose, 14.2% wt of starch, |
| | and 11.9% wt of dietary fibers |
| Protein from oats, | 40% wt |
| peas and hemp | |
| Water and other | Up to 100% wt |
| components of oat, | |
| pea and hemp | |

This combination also provided for an outstanding nutritional profile of low carbohydrates/sugars, high in dietary fibres, high in protein, high in essential amino acids and high in omega 3 and 6 fatty acids as well as an excellent ratio of total carbohydrates to dietary fibres of 3.4:1. This mixture was further subjected to optimizing the settings in the manufacture process to obtain the optimal crunch and crispiness. Here it was found that mixing full grain oats, the hemp, and the brown pea protein, and mixing the ingredients into a composition A; and sequentially or simultaneously mix in the rape seed oil, desirable spices such as wasabi powder, chili powder, ground dried basil and water and then extrude this mixture in a Coperion twin screw lab extruder using a on e hole 1.5×11 mm die plate using the below settings was most promising.

| Test | 1 | 2 | 3 | 4 |
|---|---|---|---|---|
| Recipe | A | A | A | A |
| Water contents | High | High | Low | Low |
| Screw no. | Wholi V2 | Wholi V2 | Wholi V2 | Wholi V2 |
| Screw Speed | 1470 | 1450 | 1300 | 1300 |
| Torque % | 30 | 31 | 36 | 38 |
| Torque Throughput kg/h | 35.1 | 35.0 | 37.3 | 37.1 |
| SME Wh/kg | 211 | 215 | 211 | 223 |
| Crunch test 10 = best | 9 | 9 | 10 | 9 |

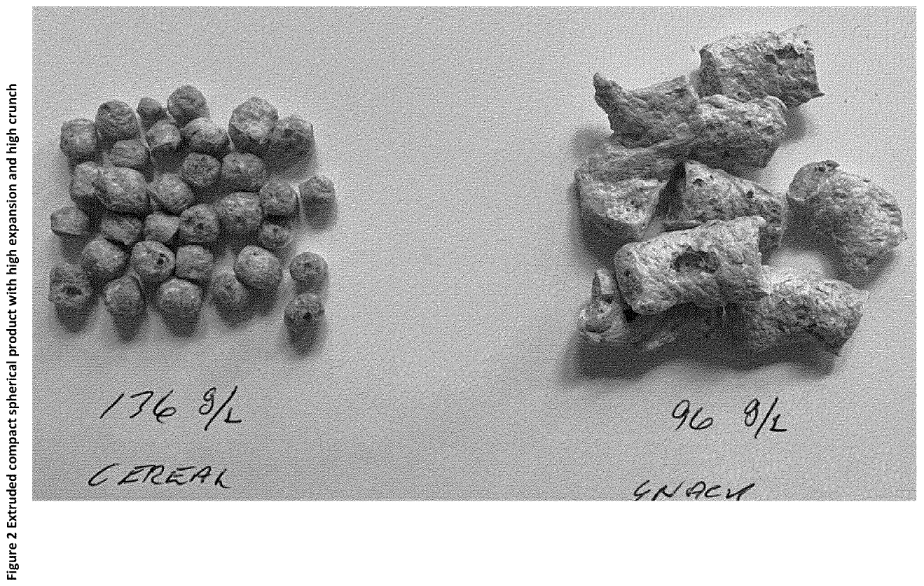

After extrusion the product was dried to a water content of less than 4% wt. The crunchiness or crispness was evaluated by a panel of 5 experienced snack food specialists. The best crunchiness (see FIG. 2) (score 10 of 10) was obtained in test 3, where the extruder was set so that a pressure of 20-25 bar and a maximum/melt temperature of between 150° C. to 180° C. was maintained during the extrusion.

1. A snack food product comprising
a) 10 wt % to 75 wt % of total carbohydrate (TC) comprising less than 20 wt % sugars, less than 50 wt % starch and at least 1 wt % dietary fibers (DF); and
b) 10 wt % to 75 wt % of protein.
The snack food product of any preceding claim wherein the total amount of carbohydrate is between 15 wt % to 50 wt %, optionally between 20 wt % to 45 wt %, optionally between 25 wt % to 40 wt %, optionally between 25 wt % to 35 wt %, optionally between 28 wt % to 32 wt %, optionally between 29 wt % to 31 wt %.

2. The snack food product of any preceding claim comprising between 1.0 wt % to 15.0 wt % sugars, optionally between 2.0 wt % to 10.0 wt % sugars, optionally between 2.0 wt % to 8.0 wt % sugars, optionally between 2.0 wt % to 6.0 wt % sugars, optionally between 3.0 wt % to 4.5 wt % sugars, optionally between 3.0 wt % to 4.5 wt % sugars, optionally between 3.8 wt % to 4.1 wt % sugars, optionally between 3.2 wt % to 3.4 wt % sugars.

3. The snack food product of any preceding claim wherein the sugars are selected from the group of glucose, fructose, sucrose, maltose, and lactose.

4. The snack food product of any preceding claim comprising between 10.0 wt % to 45.0 wt % starch, optionally between 15.0 wt % to 30.0 wt % starch, optionally between 20.0 wt % to 25.0 wt % starch, optionally between 21.0 wt % to 23.0 wt % starch, optionally between 21.9 wt % to 22.1 wt % starch, optionally between 22.8 wt % to 23.0 wt % starch.

5. The snack food product of any preceding claim comprising between 1 wt % to 20 wt % dietary fibers, optionally between 2 wt % to 18 wt % dietary fibers, optionally between 4 wt % to 16 wt % dietary fibers, optionally between 6 wt % to 14 wt % dietary fibers, optionally between 8 wt % to 12 wt % dietary fibers, optionally between 10 wt % to 12 wt % dietary fibers.

6. The snack food product of any preceding claim wherein the ratio of TC to DF (TC:DF) is between 1.0:1.0 and 10.0:1.0, optionally between 1.5:1.0 and 5.0:1.0, optionally between 2.0:1.0 and 4.9:1.0, optionally between 2.5:1 and 4:1, optionally between 2.50:1 to 2.60:1, optionally optionally between 3.7:1 to 3.9:1.

7. The snack food product of any preceding claim comprising between 10 wt % to 60 wt % protein, optionally between 15 wt % to 55 wt % protein, optionally between 20 wt % to 50 wt % protein, optionally between 25 wt % to 50 wt % protein, optionally between 30 wt % to 50 wt % protein, %, optionally between 35 wt % to 40 wt % protein, optionally between 35 wt % to 36 wt % protein, optionally between 37 wt % to 38 wt % protein.

8. The snack food product of any preceding claim wherein the protein comprises at least 10 different amino acids, optionally at least 11 different amino acids, optionally at least 12 different amino acids, optionally at least 13 different amino acids, optionally at least 14 different amino acids, optionally at least 15 different amino acids, optionally at least 16 different amino acids, optionally at least 17 different amino acids, optionally at least 18 different amino acids, optionally at least 19 different amino acids, optionally at least 20 different amino acids.

9. The snack food product of any preceding claim wherein the protein comprises at least 5 essential amino acids, optionally at least 6 essential amino acids, optionally at least 7 essential amino acids, optionally at least 8 essential amino acids, optionally at least 9 essential amino acids.

10. The snack food product of any preceding claim further comprising a source of lipid, flavour and/or moisture.

11. The snack food product of claim 10 wherein the source of oil comprises one or more unsaturated fatty acids, optionally selected the group of omega-3, omega-6 and omega-9 fatty acids.

12. The snack food product of claim 11 wherein wherein the source of lipid is a vegetable oil is selected form the group consisting of rape seed oil (Brassica napus), grape seed oil (Vitis vinifera), olive oil (Olea); sunflower oil (Helianthus annuus); soybean oil (Glycine max), corn oil (Zea mays); sesame oil (Sesamum indicum), coconut oil (Cocos nucifera), palm oil (Elaeis), avocado oil (Persea americana), safflower oil (Carthamus tinctorius).

13. The snack food product of claim 10 wherein the flavour is a spice, optionally selected from salt, peppers including chili peppers, wasabi (horse radish), mustard, basil, thyme, tomatoe, oregano, garlic, onion, majoram, rosemary, beetroot, lemon, vanilla, cocoa, caramel, honey, coffee, lime, banana, cherry, strawberry, blueberry, mint, apricot or combination thereof.

14. The snack food product of claims 10 to 13 wherein the amount of lipid is between 5 wt % to 20 wt %, optionally between 8 wt % to 10 wt %.

15. The snack food product of claims 10 to 13 wherein the flavour is a spice.

16. The snack food product of claims 10 to 15 wherein the amount of flavour is between 5 wt % to 20 wt %, optionally between 8 wt % to 10 wt %.

17. The snack food product of claim 14 comprising less than 10 wt % water, optionally less than 8 wt % water, optionally less than 6 wt % water, optionally less than 4 wt % water, optionally less than 2 wt % water, optionally less than 1 wt % water.

18. The snack food product of any preceding claim comprising carbohydrate derived from grain, optionally cereal grains, optionally one or more grains selected from wheat (Triticum aestivum), barley (Hordeum vulgare), rye (Secale cereale), oats (Avena sativa), rice (Oryza sativa), corn (Zea mays), millet (Panicum miliaceum), sorghum (Sorghum bicolor), quinoa (Chenopodium quinoa), and buckwheat (Fagopyrum esculentum).

19. The snack food product of claim 18 comprising between 20 wt % to 60 wt % grain, optionally between 25 wt % to 55 wt % grain, optionally between 30 wt % to 50 wt % grain, optionally between 30 wt % to 40 wt % grain, optionally between 33 wt % to 38 wt % grain, optionally between 34 wt % to 35 wt % grain.

20. The snack food product of any preceding claim comprising protein derived from a legume, optionally selected from the group of Soybeans (Glycine max), lentils (Lens culinaris), chickpea (Cicer arietinum), beans (Phaseolus vulgaris), peas (Pisum sativum) including green peas, brown peas and yellow split peas (Pisum sativum var. arvense).

21. The snack food product of claim 20 comprising between 20 wt % to 60 wt % legume, optionally between 25 wt % to 55 wt %, optionally between 30 wt % to 50 wt %, optionally between 30 wt % to 40 wt %, optionally between 33 wt % to 38 wt %, optionally between 34 wt % to 35 wt % legume.

22. The snack food product of claim 20 comprising between 10 wt % to 30 wt % legume protein, optionally between 12 wt % to 28 wt %, optionally between 15 wt % to 25 wt %, optionally between 15 wt % to 20 wt %, optionally between 15 wt % to 19 wt %, optionally between 17 wt % to 18 wt % legume protein.

23. The snack food product of claims 1 to 19 comprising protein is derived from hemp (Cannabis sativa).

24. The snack food product of claim 23 comprising between 15 wt % to 55 wt % hemp, optionally between 20 wt % to 50 wt %, optionally between 25 wt % to 45 wt %, optionally between 25 wt % to 35 wt %, optionally between 29 wt % to 32 wt %, optionally between 30 wt % to 31 wt % hemp.

25. The snack food product of claim 23 comprising between 9 wt % to 36 wt % hemp protein, optionally between 13 wt % to 32 wt %, optionally between 16 wt % to 29 wt %, optionally between 16 wt % to 22 wt %, optionally between 19 wt % to 21 wt %, optionally between 19.5 wt % to 19.8 wt % hemp protein.

26. The snack food product of claims 1 to 18 comprising protein derived from grain optionally selected from the group of wheat (Triticum aestivum), barley (Hordeum vulgare), rye (Secale cereale), oats (Avena sativa), rice (Oryza sativa), corn (Zea mays), millet (Panicum miliaceum), sorghum (Sorghum bicolor), quinoa (Chenopodium quinoa), and buckwheat (Fagopyrum esculentum).

27. The snack food product of claim 23 comprising between 1 wt % to 15 wt % grain protein, optionally between 2 wt % to 12 wt %, optionally between 3 wt % to 8 wt %, optionally between 4 wt % to 6 wt % grain protein.

28. The snack food product of claims 1 to 18 comprising protein derived from both legumes, hemp and grain.

29. The snack food product of any preceding claim comprising:
a) between 20 wt % to 60 wt % of ground grain, optionally between 25 wt % to 55 wt % grain, optionally between 30 wt % to 50 wt % grain, optionally between 30 wt % to 40 wt % grain, optionally between 33 wt % to 38 wt % grain, optionally between 34 wt % to 35 wt % grain, selected from wheat (Triticum aestivum), barley (Hordeum vulgare), rye (Secale cereale), oats (Avena sativa), rice (Oryza sativa), corn (Zea mays), millet (Panicum miliaceum), sorghum (Sorghum bicolor), quinoa (Chenopodium quinoa), and buckwheat (Fagopyrum esculentum);
b) between 20 wt % to 60 wt % legume, optionally between 25 wt % to 55 wt %, optionally between 30 wt % to 50 wt %, optionally between 30 wt % to 40 wt %, optionally between 33 wt % to 38 wt %, optionally between 34 wt % to 35 wt % legume, selected from the group of soybeans (Glycine max), lentils (Lens culinaris), chickpea (Cicer arietinum), beans (Phaseolus vulgaris), peas (Pisum sativum) including green peas, brown peas and yellow split peas (Pisum sativum var. arvense;
c) between 15 wt % to 55 wt % hemp, optionally between 20 wt % to 50 wt %, optionally between 25 wt % to 45 wt %, optionally between 25 wt % to 35 wt %, optionally between 29 wt % to 32 wt %, optionally between 30 wt % to 31 wt % hemp;
d) optionally between 5 wt % to 20 wt %, optionally between 8 wt % to 10 wt % oil, selected from the group of rape seed oil (Brassica napus), grape seed oil (Vitis vinifera), olive oil (Olea);
sunflower oil (Helianthus annuus); soybean oil (Glycine max), corn oil (Zea mays); sesame oil (Sesamum indicum), coconut oil (Cocos nucifera), palm oil (Elaeis), avocado oil (Persea americana), safflower oil (Carthamus tinctorius), and
e) optionally between 5 wt % to 20 wt %, optionally between 8 wt % to 10 wt % of flavour, selected from salt, peppers including chili peppers, wasabi (horse radish), mustard, basil, thyme, tomatoe, oregano, garlic, onion, majoram, rosemary, beetroot, lemon, vanilla, cocoa, caramel, honey, coffee, lime, banana, cherry, strawberry, blueberry, mint, apricot or combination thereof.

30. The snack food product of claim 1 comprising
a) between 29 wt % to 31 wt % of carbohydrates comprising
i. between 3.2 wt % to 3.4 wt % sugars comprising glucose, fructose, sucrose, maltose; and lactose;
ii. between 22.8 wt % to 23.0 wt % starch, and
iii. between 11.0 wt % to 12.0 wt % dietary fibers; and
b) between 35 wt % to 36 wt % protein, and
wherein the ratio of TC to DF (TC:DF) is between 2.50:1.0 and 2.60:1.0.

31. The snack food product of claim 1 consisting of
a) 33 to 36% wt of carbohydrates consisting of
i. 4 to 5% wt of sugars comprising glucose, fructose, sucrose, maltose; and lactose
ii. 20 to 21% wt of starch, and
iii. 9 to 10% wt of dietary fibers;
b) 31 to 35% wt of protein;
c) One or more vegetable lipids comprising omega 3; and
d) Water and spices adding up to 100%; and
wherein the ratio total carbohydrate: dietary fiber is between 3:1 and 4:1.

32. The snack food product of claim 31 comprising 34% wt of carbohydrates consisting of 4.3% wt of sugars comprising glucose, fructose, sucrose, maltose; and lactose; 20.2% wt of starch; and 9.5% wt of dietary fibers, and wherein the ratio total carbohydrate: fiber is 3.4:1.

33. The snack food product of claims 31 to 32, wherein the protein comprises at least 8 essential amino acids.

34. The snack food product of claims 31 to 33, further consisting of ground full grain oats (Avena sativa), brown pea (Pisum sativum) protein, hemp (Cannabis sativa) protein, oil of rape seed (Brassica napus), spices and water.

35. The snack food product of claims 1 to 34, further characterized by having amounts below detection limit of allergens from egg, cow's milk, fish, shellfish, peanut, tree nut, soy, wheat, sesame, or celery, and free of gluten, sulphites, acetylsalisylate and salicylate.

36. The snack food product of any preceding claim further comprising one or more added vitamins, optionally selected from vitamins A, B5, B7, B12, C, D, E, and/or K.

37. The snack food product of any preceding claim further comprising added betaglucan, isolated from oats.

38. The snack food product of any preceding claim further comprising one or more added minerals, optionally.comprising essential minerals selected from calcium, chromium, iodine, molybdenum, and selenium.

39. The snack food product of any preceding claim further comprising one or more added omega-3 fatty acid.

40. The snack food product of any preceding claim wherein the product is puffed.

41. The snack food product of any preceding claim wherein the density of the product is between 25 g/L to 200 g/L, optionally between 50 g/L to 150 g/L, optionally between 50 g/L to 100 g/L, optionally between 60 g/L to 90 g/L, optionally between 70 g/L to 80 g/L, optionally between 100 g/L to 150 g/L, optionally between 130 g/L to 140 g/L.

42. The snack food of any preceding claim wherein the product is crispy.

43. A process for producing the snack food product of claims 1 to 42 comprising
a) providing the carbohydrate and the protein and optionally water and mixing the ingredients into a composition A;
b) extruding composition A in an extruder to produce a composition B;
c) collecting and drying the extruded composition B to produce the snack food product; and
d) optionally adding a lipid and/or one or more spices to the snack food product.

44. The process of claim 43 wherein the extruder is a screw extruder, optionally having a die plate with an opening between 5 mm² to 100 mm², optionally between 10 mm² to 75 mm², optionally between 12 mm² and 50 mm², optionally between 15 mm² and 40 mm², optionally between 15 mm² and 20 mm², optionally between 15 mm² and 17 mm².

45. The process of claim 43 wherein the opening in the die plate is circular or oval or rectangular or square.

46. The process of claims 43 to 44 wherein the extrusion is made at a pressure of between 5 bar to 300 bar, 7 bar to 150 bar 7 bar to 50 bar, optionally between 10 bar to 35 bar, optionally between 15 bar to 30 bar, optionally between 20 bar to 25 bar.

47. The process of claims 43 to 46 wherein the extrusion is made at a melt temperature between 50° C. to 200° C., optionally between 100° C. to 200° C., optionally between 125° C. to 175° C., optionally between 150° C. to 175° C.

48. The process of claims 43 to 47 wherein the extrusion is made at a barrel temperature of between 25° C. to 200° C.

49. The process of claims 43 to 47 wherein the extruder provides a torque between 25% to 50%, optionally between 30% to 40%.

50. The process of claims 43 to 49 wherein the extruder provides for a throughput through the die plate of between 30 kg/h to 45 kg/h, optionally between 32 kg/h to 43 kg/h, optionally between 34 kg/h to 36 kg/h.

51. The process of claims 43 to 49 wherein the extruder is set to a screw speed of between 50 rpm to 1800 rpm, optionally between 100 rpm to 1800 rpm, optionally between 300 rpm to 1800 rpm, optionally between 600 rpm to 1800 rpm, optionally from 700 rpm to 1700 rpm, optionally from 900 rpm to 1600 rpm, optionally from 900 rpm to 1500 rpm, optionally from 1000 rpm to 1400 rpm, optionally from 1100 rpm to 1300 rpm.

52. The process for producing the snack food product of claims 43 to 51, comprising:
a) Providing ground full or whole grain oats (Avena sativa), hemp (Cannabis sativa) protein, and brown pea (Pisum sativum) protein, and mixing the ingredients into a composition A;
b) mixing composition A with rape seed oil (Brassica napus), one or more spices and water to produce a composition B;
c) extruding composition B in a screw extruder set to a screw speed of 1100 rpm to 1300 rpm comprising a die plate with an opening of between 15 mm² and 17 mm² at conditions selected to maintain i) a pressure of 20 to 25 bar and b) a maximum temperature of between 150° C. to 175° C.; and
d) collecting and drying the extruded composition B to less than 4% wt water.

53. The process for producing the snack food product of claims 43 to 51, comprising:
a) Providing ground full grain oats (Avena sativa), hemp (Cannabis sativa) protein, and brown pea (Pisum sativum) protein, and mixing the ingredients with water to produce a composition A;
b) extruding composition A in a screw extruder set to a screw speed of 1100 rpm to 1300 rpm comprising a die plate with an opening of between 15 mm² and 17 mm² at conditions selected to maintain i) a pressure of 20 to 25 bar and b) a maximum temperature of between 150° C. to 175° C.;
c) collecting and drying the extruded composition B to less than 4% wt water; and
d) optionally adding oil and flavour to the extruded composition B.

54. A packaged snack food product, comprising 15 to 500 grams of the snack food product of claims 1 to 53, optionally 15 to 100 grams, optionally 15 to 30 grams, contained in a sealed foil wrapping comprising one or more color prints on an external surface.
